(19) United States
(12) Patent Application Publication
(10) Pub. No.: US 2012/0109638 A1
(43) Pub. Date: May 3, 2012

(54) ELECTRONIC DEVICE AND METHOD FOR EXTRACTING COMPONENT NAMES USING THE SAME

(75) Inventors: WEI-QING XIAO, Shenzhen City (CN); CHUNG-I LEE, Tu-Cheng (TW); CHIEN-FA YEH, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/049,908

(22) Filed: Mar. 17, 2011

(30) Foreign Application Priority Data
Oct. 27, 2010 (CN) 201010521456.4

(51) Int. Cl. G06F 17/27

(52) U.S. Cl. 704/9

(57) ABSTRACT

A method for extracting component names from a document reads text content of the document, searches for component labels in the text content, and stores a position of each component label in the text content in a storage device. The method further extract a component name corresponding to each component label in the text content according to the position of each component label, and creates a component table according to the component label and the component name.

### BACKGROUND

1. Technical Field

Embodiments of the present disclosure relate to document analysis technology, and particularly to an electronic device and method for extracting component names from a document using the electronic device.

2. Description of Related Art

Components, such as clips, rivets, bolts, in a drawing of a document, for example, a patent document, are usually only marked with alphanumerical labels. To ascertain a component name, the component name must be located in an accompanying document, such as a specification of the patent document. It is thus less than efficient to understand the drawings of the patent document. Therefore, a more efficient method for extracting component names from a document is desired.

### BRIEF DESCRIPTION OF THE DRAWINGS

FIG. 1 is a block diagram of one embodiment of an electronic device.

FIG. 2 is a block diagram of one embodiment of a component name extracting system in the electronic device.

FIG. 3 is a flowchart of one embodiment of a method for extracting component names from a document using the electronic device.

FIG. 4 is a detailed flowchart of block S2 in FIG. 3.

FIG. 5 is a detailed flowchart of block S3 in FIG. 3.

FIG. 6 is a schematic diagram of a component table.

### DETAILED DESCRIPTION

All of the processes described below may be embodied in, and fully automated via, functional code modules executed by one or more general purpose electronic devices or processors. The code modules may be stored in any type of non-transitory readable medium or other storage device. Some or all of the methods may alternatively be embodied in specialized hardware. Depending on the embodiment, the non-transitory readable medium may be a hard disk drive, a compact disc, a digital video disc, a tape drive or other suitable storage medium.

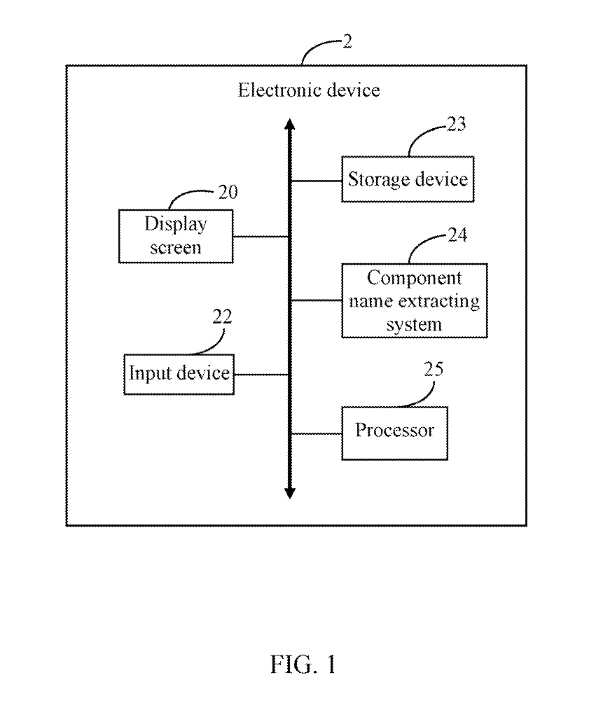

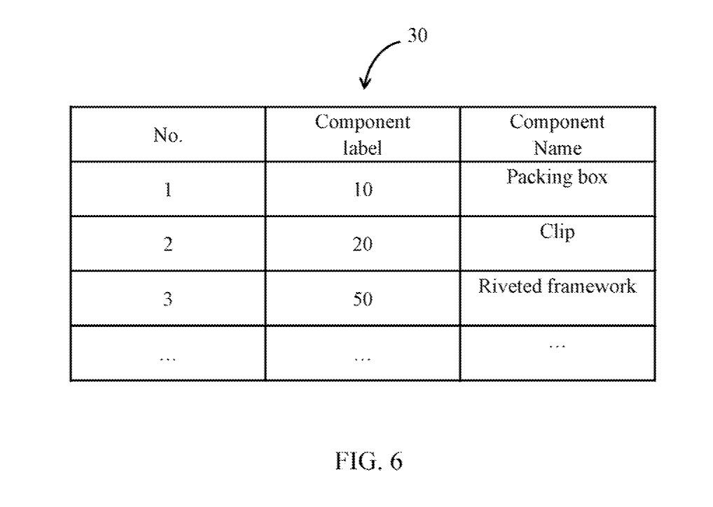

FIG. 1 is a block diagram of one embodiment of an electronic device 2, including a display screen 20, an input device 22, a storage device 23, a component name extracting system 24, and at least one processor 25. The component name extracting system 24 may be used to extract a component name in a document. The document may have a list of different components, such as clips, rivets, and bolts, corresponding to component labels in the document. The component name extracting system 24 can create a component table according to the component name and the component label. In one embodiment, the component table may be used to store component names and corresponding component labels of different components. As shown in FIG. 6, a component label of a component of “clip” is “20.”

The display device 20 may be used to display drawings of documents read from the storage device 23, and the input device 22 may be a mouse or a keyboard used to input computer readable data.

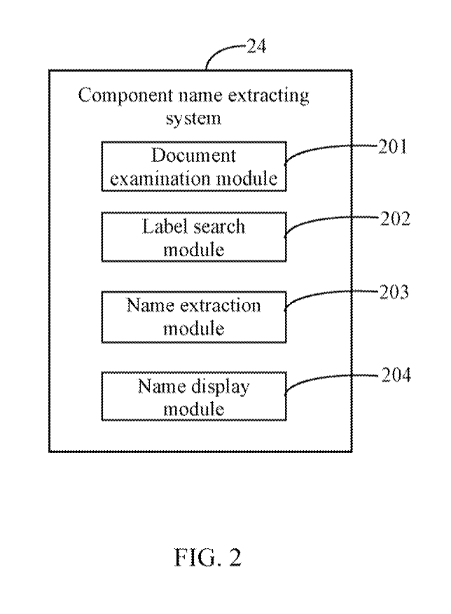

FIG. 2 is a block diagram of one embodiment of the component name extracting system 24 in the electronic device 2. In one embodiment, the component name extracting system 24 may include one or more modules, for example, a document examination module 201, a label search module 202, a name extraction module 203, and a name display module 204. The one or more modules 201-204 may comprise computerized code in the form of one or more programs that are stored in the storage device 23 (or memory). The computerized code includes instructions that are executed by the at least one processor 25 to provide functions for the one or more modules 201-204.

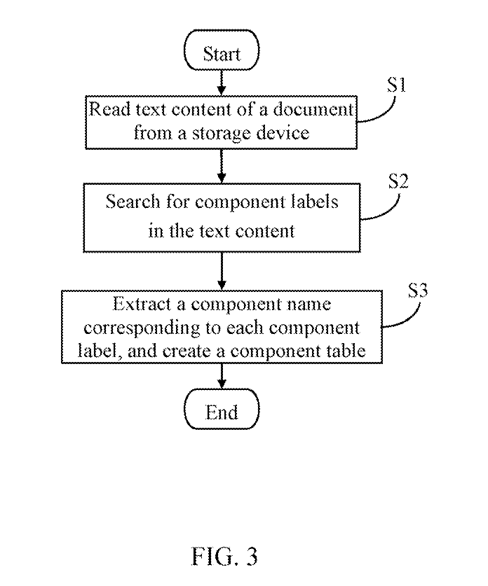

FIG. 3 is a flowchart of one embodiment of a method for extracting component names from a document using the electronic device 2. Depending on the embodiment, additional blocks may be added, others removed, and the ordering of the blocks may be changed.

In block S1, the document examination module 201 reads text content of a document from the storage device 23 of the electronic device 2. In one embodiment, the document may be a specification of a patent application in a file format, such as a MICROSOFT WORD format or PDF format. It may be understood that the document may be other document types, such as academic journals.

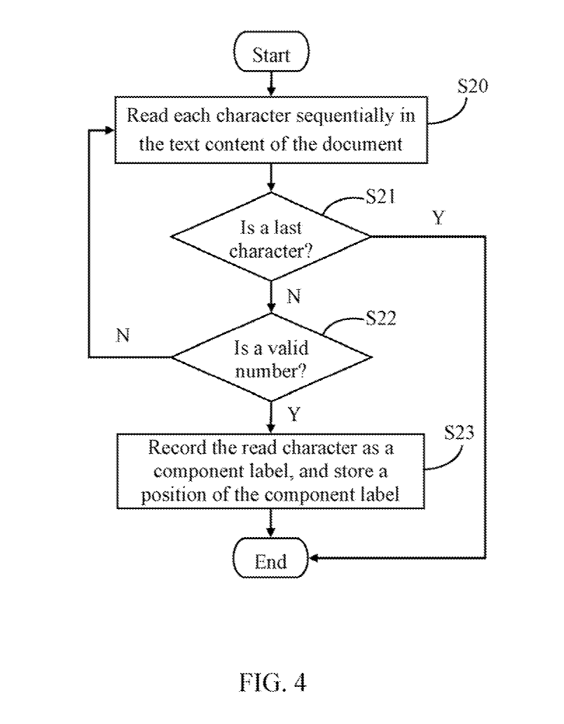

In block S2, the label search module 202 searches for component labels in the text content, and stores a position of each component label in the text content in the storage device 23. A detailed description is shown FIG. 4.

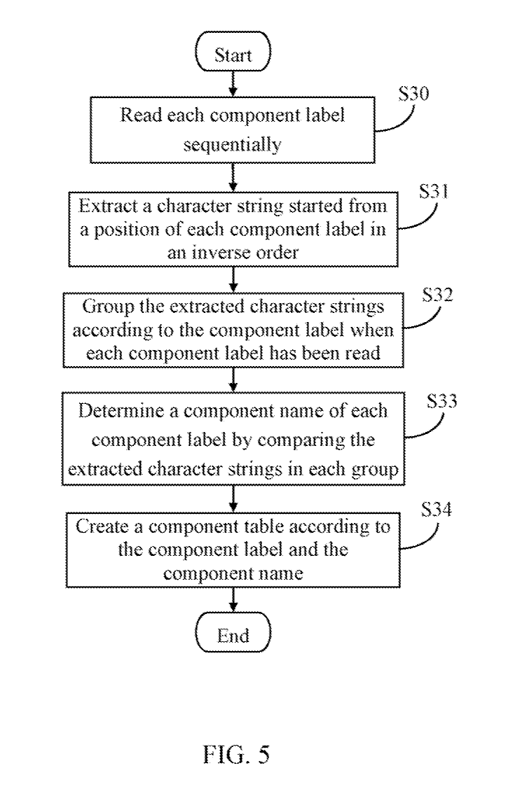

In block S3, the name extraction module 203 extracts a component name corresponding to each component label in the text content according to the position of each component label, and creates a component table 30, as shown in FIG. 6, according to the component label and the component name. A detailed description is shown in FIG. 5.

Thus, if a component label of a patent drawing is moused over, the name display module 204 obtains a component name corresponding to the component label from the component table 30, and displays the component name beside the component label.

FIG. 4 is a detailed flowchart of block S2 in FIG. 3. Depending on the embodiment, additional blocks may be added, others removed, and the ordering of the blocks may be changed.

In block S20, the label search module 202 reads each character sequentially in the text content of the document.

In block S21, the label search module 202 determines if the read character is a last character in the text content. If the read character is the last character in the text content, the procedure ends. If the read character is not the last character in the text content, block S22 is implemented. In one embodiment, the last character in the text content is an end of file (EOF) flag.

In block S22, the label search module 202 determines if the read character is a valid number. A method for determining whether the read character is the valid number or an invalid number is shown in paragraph [0022]. If the read character is an invalid number, block S20 is repeated, the label search module 202 reads a sequential character in the text content until the read character is the last character in the text content. If the read character is the valid number, block S23 is implemented.

In one embodiment, the read character is determined to be the invalid number if one of the following conditions is satisfied: (1) a first letter of the read character is “0;” (2) the read character includes a symbol of “%;” (3) the read character is a decimal fraction; and (4) the read character is followed with a specified character, such as “FIG. ” or “FIGS.” If none of the above-mentioned conditions of (1)-(4) is satisfied, the read character is determined to be the valid number.

In block S23, the label search module 202 records the read character as a component, and stores a position of the component label in the storage device 23. In one embodiment, the position of the component label is a sequence number of the component label in the text content. For example, if the component label is the fifteenth character in the text content, the position of the component label is 15.

FIG. 5 is a detailed flowchart of block S3 in FIG. 3. Depending on the embodiment, additional blocks may be added, others removed, and the ordering of the blocks may be changed.

In block S30, the name extraction module 203 reads each component label sequentially from the text content of the document according to the position of each component label.

In block S31, the name extraction module 203 extracts a character string started from the position of each component label in an inverse order. It may be understood that the name extraction module 203 sorts an original extracted character string according to the inverse order to obtain an extracted character string.

For example, if text content include the following contents “. . . connector body 20 is also generally cylindrical in shape with first and second ends 36, and a first portion 45 of the connector body . . . ,” the name extraction module 203 extracts ten characters started from the position of the component label “36” in the inverse order to obtain an original extracted character string “ends second and first with shape in cylindrical generally also.” Then, the name extraction module 203 sorts the original extracted character string according to the inverse order to obtain an extracted character string “also generally cylindrical in shape with first and second ends.”

In one embodiment, if an extracted character string satisfies a preset format, the name extraction module 203 divides the extracted character string into a plurality of sub-strings. The preset format may be “xxx xx, yyyy yy A1, A2” or “xxx xx and yyyy yy A1, A2,” the name extraction module 203 divides the extracted character string into “xxx xx A1” and “yyyy yy A2”. For example, the name extraction module 203 divides an extracted character string of “a first flat surface and a second flat surface 68, 70” into “a first flat surface 68” and “a second flat surface 70.”

In block S32, the name extraction module 203 groups the extracted character strings according to the component label when each component label in the text content has been read.

In block S33, the name extraction module 203 determines a component name of each component label by comparing the extracted character strings in each group of the component label. In one embodiment, the component name of each component label is a longest matched string in each group of the component label. For example, if a group of a component label “20” includes two extracted character strings: “a connector body” and “the connector body,” the longest matched string in the group of the component label “20” is “connector body.” Thus, the component name of the component label “20” is determined as “connector body.”

In other embodiments, if a group of a component label includes only one extracted character string, the name extraction module 203 searches for a first specified symbol started from a position of the component label in the inverse order, and extracts characters between the first specified symbol and the component label from the extracted character string. The extracted characters are regarded as a component name corresponding to the component label. In one embodiment, the specified symbol is selected from the group comprising “a”, “an”, and “the.” For example, if a group of a component label “60” includes only one extracted character string: “receive a friction reducing device, such as an O-ring 60” the name extraction module 203 extracts characters between “an” and “60” to obtain the extracted characters “O-ring.” Thus, the component name of the component label “60” is determined as “O-ring.”

If no specified symbol is found in the extracted character string, the name extraction module 203 determines that the component label is invalid.

In block S34, the name extraction module 203 creates the component table 30 according to the component label and the component name.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method for extracting component names from a document, the method comprising:
reading text content of the document from a storage device of an electronic device;
searching for component labels in the text content, and storing a position of each component label in the text content in the storage device; and
extracting a component name corresponding to each component label in the text content according to the position of each component label, and creating a component table according to the component label and the component name.

2. The method according to claim 1, wherein the position of the component label is a sequence number of the component label in the text content.

3. The method according to claim 1, wherein the step of searching for each component label in the text content comprises:
reading each character sequentially in the text content;
determining if the read character is a valid number upon the condition that the read character is not a last character in the text content;
reading a sequential character in the text content until the read character is the last character in the text content upon the condition that the read character is an invalid number; and
recording the read character as a component label upon the condition that the read character is the valid number, and storing a position of the component label in the storage device.

4. The method according to claim 3, wherein the read character is determined to be an invalid number if one of the following conditions is satisfied: (1) a first letter of the read character is “0;” (2) the read character includes a symbol of “%;” (3) the read character is a decimal fraction; and (4) the read character is followed with a specified character.

5. The method according to claim 1, wherein the step of extracting a component name corresponding to each component label in the text content comprises:
reading each component label sequentially from the text content according to the position of each component label;
extracting a character string started from the position of each component label in an inverse order;
grouping the extracted character strings according to the component label upon the condition that each component label in the text content has been read;
determining a component name of each component label by comparing the extracted character strings in each group of the component label, the component name of each component label being a longest matched string in each group of the component label; and
creating a component table according to the component label and the component name.

6. The method according to claim 5, wherein the step of grouping the extracted character strings according to the component label further comprises: dividing an extracted character string into a plurality of sub-strings upon the condition that the extracted character string satisfies a preset format.

7. The method according to claim 5, wherein the step of extracting a component name corresponding to each component label in the text content further comprises:
searching for a first specified symbol started from a position of a component label in an inverse order upon the condition that a group of the component label includes only one extracted character string;
extracting characters between the first specified symbol and the component label from the extracted character string, the extracted characters being regarded as a component name corresponding to the component label; and
determining that the component label is invalid upon the condition that no specified symbol is found.

8. The method according to claim 7, wherein the specified symbol is selected from the group comprising “a”, “an”, and “the.”

9. An electronic device, comprising:
a storage device;
at least one processor; and
one or more modules that are stored in the storage device and are executed by the at least one processor, the one or more modules comprising instructions:
to read text content of the document from a storage device of the electronic device;
to search for component labels in the text content, and store a position of each component label in the text content in the storage device; and
to extract a component name corresponding to each component label in the text content according to the position of each component label, and create a component table according to the component label and the component name.

10. The electronic device according to claim 9, wherein the instruction to search for each component label in the text content comprises:
reading each character sequentially in the text content;
determining if the read character is a valid number upon the condition that the read character is not a last character in the text content;
reading a sequential character in the text content until the read character is the last character in the text content upon the condition that the read character is an invalid number; and
recording the read character as a component label upon the condition that the read character is the valid number, and storing a position of the component label in the storage device.

11. The electronic device according to claim 10, wherein the read character is determined to be an invalid number if one of the following conditions is satisfied: (1) a first letter of the read character is “0;” (2) the read character includes a symbol of “%;” (3) the read character is a decimal fraction; and (4) the read character is followed with a specified character.

12. The electronic device according to claim 9, wherein the instruction to extract a component name corresponding to each component label in the text content comprises:
reading each component label sequentially from the text content according to the position of each component label;
extracting a character string started from the position of each component label in an inverse order;
grouping the extracted character strings according to the component label upon the condition that each component label in the text content has been read;
determining a component name of each component label by comparing the extracted character strings in each group of the component label, the component name of each component label being a longest matched string in each group of the component label; and
creating a component table according to the component label and the component name.

13. The electronic device according to claim 12, wherein the instruction to group the extracted character strings according to the component label further comprises: dividing an extracted character string into a plurality of sub-strings upon the condition that the extracted character string satisfies a preset format.

14. The electronic device according to claim 12, wherein the instruction to extract a component name corresponding to each component label in the text content further comprises:
searching for a first specified symbol started from a position of a component label in an inverse order upon the condition that a group of the component label includes only one extracted character string;
extracting characters between the first specified symbol and the component label from the extracted character string, the extracted characters being regarded as a component name corresponding to the component label; and
determining that the component label is invalid upon the condition that no specified symbol is found.

15. A non-transitory storage medium having stored thereon instructions that, when executed by a processor of an electronic device, causes the processor to perform a method for extracting component names from a document, the method comprising:
reading text content of the document from a storage device of an electronic device;
searching for component labels in the text content, and storing a position of each component label in the text content in the storage device; and
extracting a component name corresponding to each component label in the text content according to the position of each component label, and creating a component table according to the component label and the component name.

16. The non-transitory storage medium according to claim 15, wherein the step of searching for each component label in the text content comprises:
reading each character sequentially in the text content;
determining if the read character is a valid number upon the condition that the read character is not a last character in the text content;
reading a sequential character in the text content until the read character is the last character in the text content upon the condition that the read character is an invalid number; and
recording the read character as a component label upon the condition that the read character is the valid number, and storing a position of the component label in the storage device.

17. The non-transitory storage medium according to claim 16, wherein the read character is determined to be an invalid number if one of the following conditions is satisfied: (1) a first letter of the read character is “0;” (2) the read character includes a symbol of “%;” (3) the read character is a decimal fraction; and (4) the read character is followed with a specified character.

18. The non-transitory storage medium according to claim 15, wherein the step of extracting a component name corresponding to each component label in the text content comprises:
read each component label sequentially from the text content according to the position of each component label;
extracting a character string started from the position of each component label in an inverse order;
grouping the extracted character strings according to the component label upon the condition that each component label in the text content has been read;
determining a component name of each component label by comparing the extracted character strings in each group of the component label, the component name of each component label being a longest matched string in each group of the component label; and
creating a component table according to the component label and the component name.

19. The non-transitory storage medium according to claim 18, wherein the step of grouping the extracted character strings according to the component label further comprises: dividing an extracted character string into a plurality of sub-strings upon the condition that the extracted character string satisfies a preset format.

20. The non-transitory storage medium according to claim 18, wherein the step of extracting a component name corresponding to each component label in the text content further comprises:
searching for a first specified symbol started from a position of a component label in an inverse order upon the condition that a group of the component label includes only one extracted character string;
extracting characters between the first specified symbol and the component label from the extracted character string, the extracted characters being regarded as a component name corresponding to the component label; and
determining that the component label is invalid upon the condition that no specified symbol is found.
